(19) United States
(12) Patent Application Publication
(10) Pub. No.: US 2015/0341301 A1
(43) Pub. Date: Nov. 26, 2015

(54) SENDER SPECIFIED MESSAGE NOTIFICATION

(71) Applicant: Lenovo (Singapore) Pte. Ltd., Singapore (SG)

(72) Inventors: Nathan J. Peterson, Durham, NC (US); Arnold S. Weksler, Raleigh, NC (US); Russell Speight VanBlon, Raleigh, NC (US); John Carl Mese, Cary, NC (US)

(73) Assignee: Lenovo (Singapore) Pte. Ltd., Singapore (SG)

(21) Appl. No.: 14/284,003

(22) Filed: May 21, 2014

(51) Int. Cl. H04L 12/58; G06F 3/0484

(52) U.S. Cl. CPC H04L 51/24; G06F 3/04847; G06F 3/04842

(57) ABSTRACT

A method includes obtaining a user sender message to be sent to a user receiver via a user sender device, identifying whether or not to provide an interrupting notification to the user receiver that a message has been received, and sending the message with an indication of whether or not to interruptingly notify the user receiver.

### BACKGROUND

Messages generally cause a user receiver specified notification. When the receiver goes to bed, many leave their message receiving devices on, with notifications turned on in case an important message is received. Unfortunately, messages that are not important may also trigger the notification, interrupting the receiver at times they may really only want to be notified for important messages.

### SUMMARY

A method includes obtaining a user sender message to be sent to a user receiver via a user sender device, identifying whether or not to provide an interrupting notification to the user receiver that a message has been received, and sending the message with an indication of whether or not to interruptingly notify the user receiver.

A machine readable storage device has instructions for execution by a processor of the machine to perform obtaining a user sender message to be sent to a user receiver via a user sender device, identifying whether or not to provide an interrupting notification to the user receiver that a message has been received, and sending the message with an indication of whether or not to interruptingly notify the user receiver.

A device includes a processor and a memory device has a program stored thereon for execution by the processor to obtain a user sender message to be sent to a user receiver via a user sender device, identify whether or not to provide an interrupting notification to the user receiver that a message has been received, and send the message with an indication of whether or not to interruptingly notify the user receiver.

### BRIEF DESCRIPTION OF THE DRAWINGS

FIG. 1 is a block diagram of a user interface for selecting notification criteria for a receiver of a communication according to an example embodiment.

FIG. 2 is a block diagram of a user interface for selecting a schedule for notification of a receiver of a communication according to an example embodiment.

FIG. 3 is a flowchart illustrating a method of selecting interruption preferences for notifications of receivers of communications according to an example embodiment.

FIG. 4 is a flowchart illustrating a method of selecting interruption preferences for identifying a time to interrupt a receiver of a communication according to an example embodiment.

FIG. 5 is a block diagram of a data structure identifying interruption preferences for selecting notification criteria for a receiver of a communication according to an example embodiment.

FIG. 6 is a flowchart illustrating a method of notifying a receiver of a communication having interruption preferences according to an example embodiment.

FIG. 7 is a block diagram of processing circuitry to implement methods according to example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A user sending a message is provided with the ability to select whether or not they desire that a receiver of the message be interrupted with an interrupting notification. An interrupting notification may be identified by the user sending the message as a notification that might wake up a receiver, such as an audible notification or a vibration notification. The user may even identify visible notifications, such as blinking lights, as an interrupting notification.

In various embodiments, a user sending a message may utilize a schedule for each receiver identifying whether or not to use an interrupting notification in accordance with the schedule. The user sending the message may also simply select the type of notification for the message. In some embodiments, the message may be a text message, email message, an advertisement, or any other type of communication. In still further embodiments, the user sending the message may indicate a time by which they would like an interrupting notification to be made, say after 8 AM in the morning. In still further embodiments, a sender may indicate to interrupt the receiver with a notification if the receiver had recently used the device on which the message is received.

A receiving user, referred to as a receiver or user receiver, may override any of the notification preferences included in a received message. This may be done by simply turning off a device, or indicating a preference for notifying regardless of the preference included in the received message.

Some advantages of different embodiments include the ability to be considerate when sending messages late at night. For example, if staying up late to watch a game, or if in a very different time zone, a user can be considerate and set notification preferences to not interrupt a receiver if they believe it is not likely they would be awake or otherwise able to view the message. The preferences can also be set based on importance of the message. Medical emergency messages or messages regarding moments just too good not to instantly share may be sent without suppressing interruption notifications.

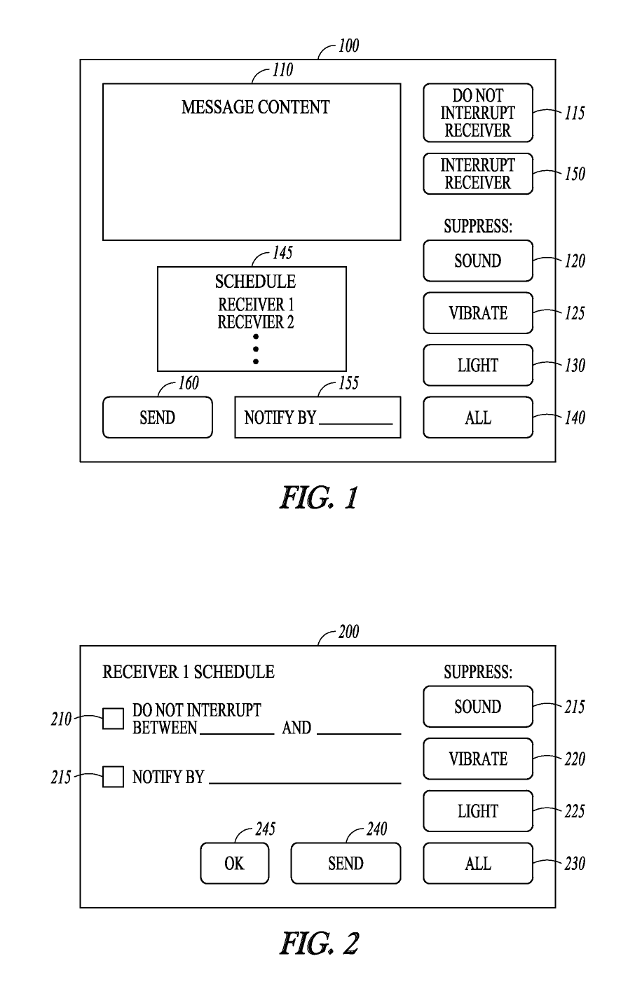

FIG. 1 is a block diagram of a user interface 100 for selecting notification criteria for a receiver of a communication according to an example embodiment. An input area 110 provides an area for a sending user to enter or import text, pictures, and other data to send to a receiver device as a message, email, or other type of communication. Several user interface constructs, such as checkboxes, buttons, and other mechanisms provide users the ability to select notification preferences indicating whether or not to interruption notify the receiver or receivers of the communication.

At 115, a construct is provided to allow the user to specify whether or not to interrupt the receiver. Different notifications may be suppressed if construct 115 is selected. Constructs provide the ability to respectively select suppression of sound at 120, vibration at 125, light at 130, and all of the selections at 140. A schedule user interface construct 145 provides a list of potential receivers to select for specifying preferences. A schedule may be provided for each receiver indicating when the receiver should be interrupted. The schedule may be used to determine whether or not to interrupt the receiver unless overridden by selection of constructs 115, 120, 125, 130, and 140.

A user may indicate at 150 to interrupt the receiver regardless of the schedule set for each user at 145. A notify by construct 155 provides a user the ability to specify when to interrupt the receiver by to ensure that the receiver notices the message. The user may fill in a time, such as 8 AM or other time when they believe the receiver will be amenable to interruption. A send button 160 may also indicate when to send the message with the selected preferences. Sending the message with a notification may include actual concatenation of the preferences with the message, may involve pointing to preference, and may even involve sending the preferences prior to the message. The preferences may thus be logically associated with the corresponding message in many different ways. Communication protocols may further separate the message and preferences into packets. In various embodiments, the receiver may override the selected preferences.

FIG. 2 is a block diagram of a user interface 200 for selecting a schedule for notification of a receiver of a communication according to an example embodiment. When a user selects a receiver from the previous schedule user interface construct 145, user interface 200 may be presented for that receiver. Several preferences may be set in user interface 200, including fields for specification of one or more time periods during which the receiver should not be interrupted at 210, several different notification suppression options including sound 215, vibrate 220, light 225, and all 230. A notify by construct 235 may also be used to specify a time to interrupt the user if the message has not already been read, and a send button 240 may also be provided if a message is ready to send. An ok button 245 may be provided to allow a user to set up preferences for multiple users prior to sending a message.

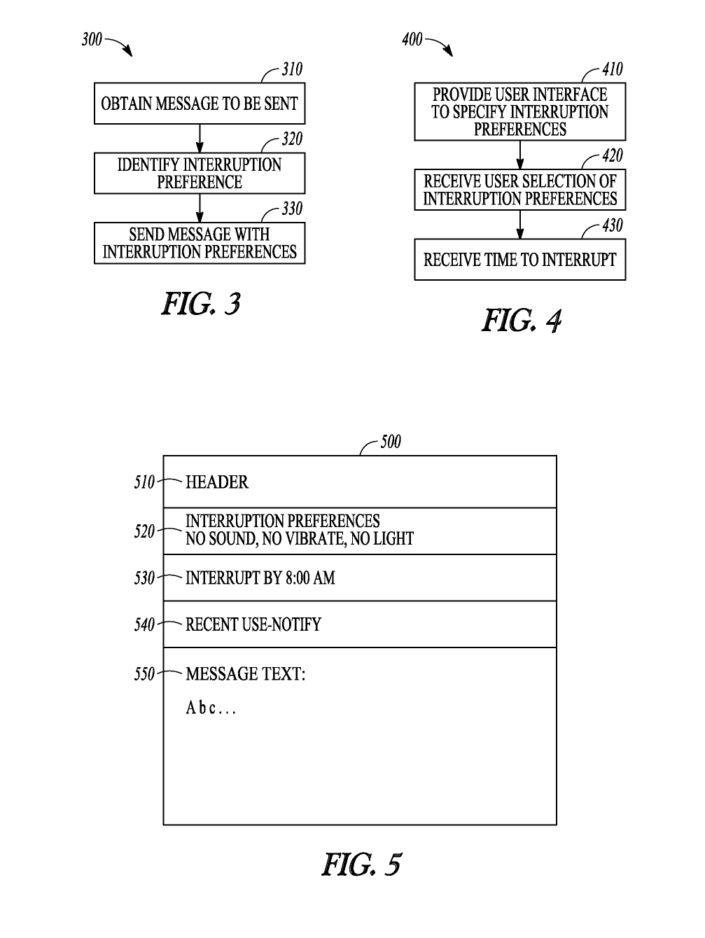

FIG. 3 is a flowchart illustrating a method 300 of selecting interruption preferences for notifications of receivers of communications according to an example embodiment. At 310, a user sender message to be sent to a user receiver via a user sender device is obtained. At 320, method 300 identifies whether or not to provide an interrupting notification to the user receiver that a message has been received. At 330, the message is sent with an indication of whether or not to interruptingly notify the user receiver. The indication of whether or not to interruptingly notify the user prior to sending the message may be obtained from a schedule on the user sender device, received from the user sender, such as by selecting the previously described preference constructs or by default from a list of users having specified preferences that were previously created by the sender user or otherwise obtained.

In one embodiment, the message may include a time for the user receiver device to provide an interrupting notification following receipt of the message.

FIG. 4 is a flowchart illustrating a method 400 of selecting interruption preferences for identifying a time to interrupt a receiver of a communication according to an example embodiment. In one embodiment, the indication of whether or not to interruptingly notify the user prior to sending the message includes providing a user interface selection construct at 410 that provides an option to interruptingly notify or not interruptingly notify. At 420, the method receives a user selection to interruptingly notify or not interruptingly notify via the user interface selection construct. At 430, the method may receive an indication of a time to interrupt the receiver provided the receiver has not already viewed the message. The user selection and time to interrupt may be entered by a user for each message, may be obtained from a previously configured schedule for a user or users, or may be defaulted to system or user selected interrupting notification preferences in various embodiments.

In some embodiments, the message may specific to provide an interrupting notification if the user receiver device has recently been used by the user receiver. The interrupting notification is provided if the user receiver device has been used within five minutes following the user device being used by the user receiver. Other times may also be specified as desired, such as 10 minutes, or 3 minutes or any other time which may be based on knowledge of the receiver's habits combined with the sender's desire not to interrupt the receiver.

FIG. 5 is a high level block diagram indicating information 500 associated with a message identifying interruption preferences for selecting notification criteria for a receiver of a communication according to an example embodiment. A header 510 may take the form of a standard communication header with message sender and receiver identification information and other data commonly associated with communications. Interruption preferences are represented at 520 and may include preferences indicating whether or not to interrupt the receiver as well as what is viewed as an interrupting notification. Sound, light, and vibration type notifications are identified and addressed in the preferences. At 530, and indication may be provided specifying a time to interrupt the receiver if they have not already viewed the message. A recently used indication at 540 may be used to determine if the receiver is likely still in a state in which they can be interrupted without being adversely disrupted. Indication 540 may specify a time frame from which to determine if the receiver is amenable to being interrupted with a notification. A message section 550 may include a message from the user sender, such as text, graphics, pictures, etc. The message may be in the form of an email, text message, advertisement, or other communication in various embodiments.

In some embodiments, the user sender, rather than being an individual user may be an automated sender of communications, such as advertisements. The advertisements may utilize preferences set as above for individual receivers of the communications, or tailored for each advertisement communication. Weather warnings for example may be set to always interrupt a receiver. A communication including a coupon for coffee, may for example have a notify by time corresponding to a particular time when a receiver may be taking a coffee break, commuting to work, or otherwise might be interested in obtaining coffee. The messages may be sent any time, and timed to notify at such desired times.

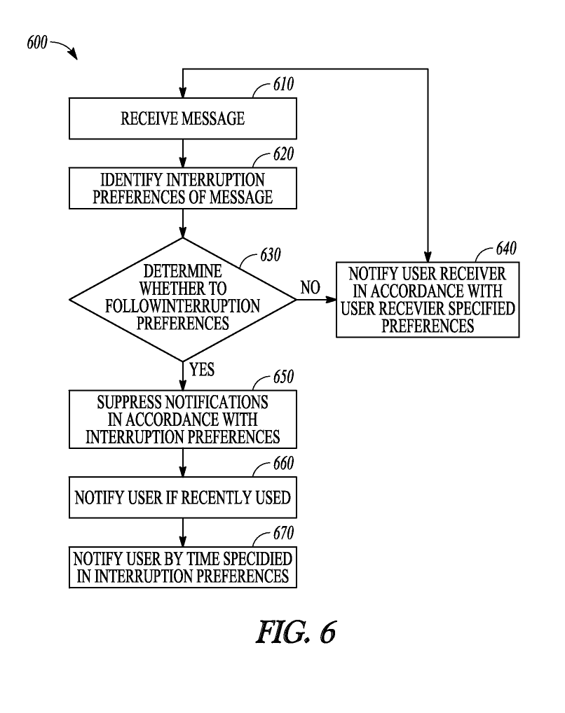

FIG. 6 is a flowchart illustrating a method 600 of notifying a receiver of a communication having interruption preferences according to an example embodiment. At 610, the message may be received. The message may contain or point to notification information as described at 500 in FIG. 5 from which the receiver may determine what the interruption preferences of the message are at 620. At 630, it is determined whether to follow the interruption preferences or not. If not, the user may be notified at 640 in accordance with the receiver's specified preferences. Note that if the receiver device is turned off or otherwise has notifications cancelled, the receiver may not be notified at 640.

If the receiver device is receiving and processing interruption preferences, the preferences may be followed at 650, and notifications identified may be suppressed. At 660, however, if the receiver has recently used the receiver device or other device in communication with the device, the receiver may be notified. This may occur whether or not the sender specified that the receiver be so notified, depending on the preferences of the receiver. At 670, if the sending user indicated a time to be notified, the receiver may be notified at the time specified in the interruption preferences, even if the message was received some time ago. The notification may also be suppressed if the receiver has already viewed the message.

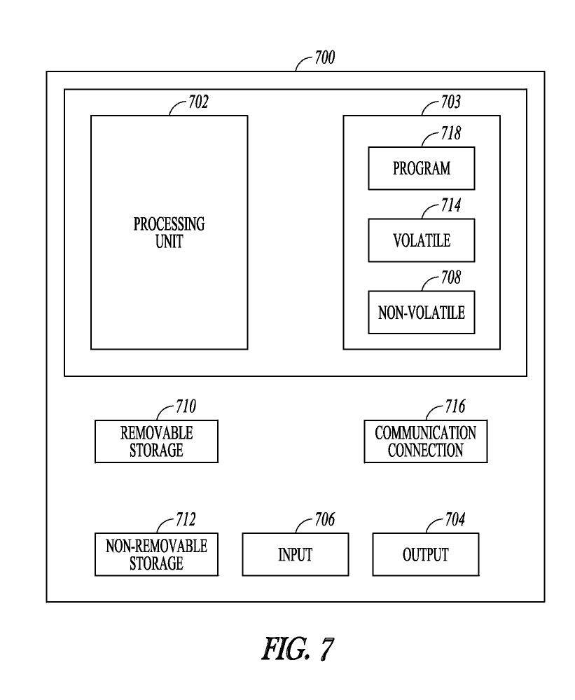

FIG. 7 is a block schematic diagram of processing circuitry in the form of a computer system 700 to implement methods according to example embodiments. All components need not be used in various embodiments. One example computing device in the form of a computer 700, may include a processing unit 702, memory 703, removable storage 710, and non-removable storage 712. Sensors 115 and 125 may be coupled to provide data to the processing unit 702. Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. Output 704 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 702 of the computer 700. A hard drive, CD-ROM, and RAM are some examples of articles including a non-transitory computer-readable medium. For example, a computer program 718 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 700 to provide generic access controls in a COM based computer network system having multiple users and servers.

### Examples

1. A method comprising:

obtaining a user sender message to be sent to a user receiver via a user sender device;

identifying whether or not to provide an interrupting notification to the user receiver that a message has been received; and

sending the message with an indication of whether or not to interruptingly notify the user receiver.

2. The method of example 1 wherein the indication of whether or not to interruptingly notify the user prior to sending the message is received from the user sender.

3. The method of example 2 wherein the message is a text message, and wherein the indication of whether or not to interruptingly notify the user prior to sending the message comprises:
providing a user interface selection construct providing an option to interruptingly notify or not interruptingly notify; and
receiving a user selection to interruptingly notify or not interruptingly notify via the user interface selection construct.

4. The method of any of examples 2-3 wherein not providing an interrupting notification comprises no notification to the user receiver.

5. The method of any of examples 2-4 wherein not providing an interrupting notification comprises no vibration and no audible notification.

6. The method of any of examples 1-5 wherein identifying whether or not to interruptingly notify the user receiver is performed in accordance with a schedule on the user sender device.

7. The method of any of examples 1-6 and further comprising setting a time for the user receiver device to provide an interrupting notification following receipt of the message.

8. The method of any of examples 1-7 and further comprising allowing the user receiver device to provide an interrupting notification if the user receiver device has recently been used by the user receiver.

9. The method of example 8 wherein the interrupting notification is provided if the user receiver device has been used within five minutes following the user device being used by the user receiver.

10. The method of any of examples 1-9 wherein the message comprises a text message entered on the user sender device.

11. A machine readable storage device having instructions for execution by a processor of the machine to perform:
obtaining a user sender message to be sent to a user receiver via a user sender device;

identifying whether or not to provide an interrupting notification to the user receiver that a message has been received; and

sending the message with an indication of whether or not to interruptingly notify the user receiver.

12. The machine readable storage device of example 11 wherein the indication of whether or not to interruptingly notify the user prior to sending the message is received from the user sender.

13. The machine readable storage device of example 12 wherein the message is a text message, and wherein the indication of whether or not to interruptingly notify the user prior to sending the message comprises:

providing a user interface selection construct providing an option to interruptingly notify or not interruptingly notify; and

receiving a user selection to interruptingly notify or not interruptingly notify via the user interface selection construct.

14. The machine readable storage device of any of examples 12-13 wherein not providing an interrupting notification comprises no vibration and no audible notification.

15. The machine readable storage device of any of examples 11-14 wherein identifying whether or not to interruptingly notify the user receiver is performed in accordance with a schedule on the user sender device.

16. The machine readable storage device of any of examples 11-15 and further comprising instructions for execution by a processor of the machine to perform allowing the user receiver device to provide an interrupting notification if the user receiver device has recently been used by the user receiver.

17. A device comprising:

a processor; and

a memory device having a program stored thereon for execution by the processor to:

obtain a user sender message to be sent to a user receiver via a user sender device;

identify whether or not to provide an interrupting notification to the user receiver that a message has been received; and

send the message with an indication of whether or not to interruptingly notify the user receiver.

18. The device of example 17 wherein the indication of whether or not to interruptingly notify the user prior to sending the message is received from the user sender.

19. The device of example 18 wherein the message is a text message, and wherein the indication of whether or not to interruptingly notify the user prior to sending the message comprises:

a module to provide a user interface selection construct providing an option to interruptingly notify or not interruptingly notify; and

a module to receive a user selection to interruptingly notify or not interruptingly notify via the user interface selection construct.

20. The device of any of examples 18-19 wherein not providing an interrupting notification comprises no vibration and no audible notification and wherein identifying whether or not to interruptingly notify the user receiver is performed in accordance with a schedule on the user sender device.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
obtaining a user sender message to be sent to a user receiver via a user sender device;
identifying whether or not to provide an interrupting notification to the user receiver that a message has been received; and
sending the message with an indication of whether or not to interruptingly notify the user receiver.

2. The method of claim 1 wherein the indication of whether or not to interruptingly notify the user prior to sending the message is received from the user sender.

3. The method of claim 2 wherein the message is a text message, and wherein the indication of whether or not to interruptingly notify the user prior to sending the message comprises:
providing a user interface selection construct providing an option to interruptingly notify or not interruptingly notify; and
receiving a user selection to interruptingly notify or not interruptingly notify via the user interface selection construct.

4. The method of claim 2 wherein not providing an interrupting notification comprises no notification to the user receiver.

5. The method of claim 2 wherein not providing an interrupting notification comprises no vibration and no audible notification.

6. The method of claim 1 wherein identifying whether or not to interruptingly notify the user receiver is performed in accordance with a schedule on the user sender device.

7. The method of claim 1 and further comprising setting a time for the user receiver device to provide an interrupting notification following receipt of the message.

8. The method of claim 1 and further comprising allowing the user receiver device to provide an interrupting notification if the user receiver device has recently been used by the user receiver.

9. The method of claim 8 wherein the interrupting notification is provided if the user receiver device has been used within five minutes following the user device being used by the user receiver.

10. The method of claim 1 wherein the message comprises a text message entered on the user sender device.

11. A machine readable storage device having instructions for execution by a processor of the machine to perform:
obtaining a user sender message to be sent to a user receiver via a user sender device;
identifying whether or not to provide an interrupting notification to the user receiver that a message has been received; and
sending the message with an indication of whether or not to interruptingly notify the user receiver.

12. The machine readable storage device of claim 11 wherein the indication of whether or not to interruptingly notify the user prior to sending the message is received from the user sender.

13. The machine readable storage device of claim 12 wherein the message is a text message, and wherein the indication of whether or not to interruptingly notify the user prior to sending the message comprises:
providing a user interface selection construct providing an option to interruptingly notify or not interruptingly notify; and
receiving a user selection to interruptingly notify or not interruptingly notify via the user interface selection construct.

14. The machine readable storage device of claim 12 wherein not providing an interrupting notification comprises no vibration and no audible notification.

15. The machine readable storage device of claim 11 wherein identifying whether or not to interruptingly notify the user receiver is performed in accordance with a schedule on the user sender device.

16. The machine readable storage device of claim 11 and further comprising instructions for execution by a processor of the machine to perform allowing the user receiver device to provide an interrupting notification if the user receiver device has recently been used by the user receiver.

17. A device comprising:
a processor; and
a memory device having a program stored thereon for execution by the processor to:
obtain a user sender message to be sent to a user receiver via a user sender device;
identify whether or not to provide an interrupting notification to the user receiver that a message has been received; and
send the message with an indication of whether or not to interruptingly notify the user receiver.

18. The device of claim 17 wherein the indication of whether or not to interruptingly notify the user prior to sending the message is received from the user sender.

19. The device of claim 18 wherein the message is a text message, and wherein the indication of whether or not to interruptingly notify the user prior to sending the message comprises:
a module to provide a user interface selection construct providing an option to interruptingly notify or not interruptingly notify; and
a module to receive a user selection to interruptingly notify or not interruptingly notify via the user interface selection construct.

20. The device of claim 18 wherein not providing an interrupting notification comprises no vibration and no audible notification and wherein identifying whether or not to interruptingly notify the user receiver is performed in accordance with a schedule on the user sender device.
